(19) United States
(12) Patent Application Publication
(10) Pub. No.: US 2005/0017526 A1
(43) Pub. Date: Jan. 27, 2005

(54) Pen-sized telescoping electromagnet

(76) Inventor: George Arrotta, Newburgh, NY (US)

Correspondence Address: William L. Muckelroy, Esq., P.C.;Ewing Professional Park, Suite 3A, 1901 N. Olden Avenue, Trenton, NJ, 08618, US

(21) Appl. No.: 10/623,236

(22) Filed: Jul. 21, 2003

(51) Int. Cl. B25J 15/06; B66C 1/04

(52) U.S. Cl. 294/65.5

(57) ABSTRACT

A flexible telescoping electromagnetic tool comprises an end cap formed of a magnetizable material and an end section formed of a non-magnetizable material. The end cap is connected to the end section. A tubular section is formed of a non-magnetizable material wherein the tubular section slidably receives the end section. An electrically conducting insert is disposed through the tubular section and through the end section. The conducting insert is electrically connected to a power supply. The module is attached to the distal end of the non-magnetizable tubular section. The electromagnetic tool also has a ring insert secured to the end section. The ring insert is formed of plastic and has a width that is greater than a diameter of the opening. The ring insert is attached inside said tubular section. The insert connects to an inductor. The inductor has two contacts and is near the end cap.

### PRIORITY DATE CLAIMED

No priority date is claimed for this application.

### BACKGROUND OF THE INVENTION

1. Field of the Invention

The invention relates to the location and retrieval of magnetically attractable objects using electromagnetic means disposed at an end of a flexible member.

2. Description of Prior Art

Various magnetic pick-up devices for magnetically attractable items are known which include a flexible shaft for manipulating a magnet on the end of the shaft into an area, which is otherwise inaccessible. In many of such devices, the magnet employed is of small size for accessing small areas but is of insufficient strength to retrieve the desired item. In addition, such devices are often needed in tight places surrounded by metal parts, which are also magnetically attractable. Consequently, it is difficult to control the positioning of the magnet in such environments particularly since the flexible shaft enables the magnet to be drawn towards such surrounding metal parts.

Various magnetic devices are known for varying the strength of a magnet and include compound magnet systems where the relative orientation of two or more magnets is adjusted to adjust the magnetic force. In addition, magnetic tools are known where the internal distance between a magnet and a working face is adjusted to decrease the magnetic force applied at the face. However, these types of devices often do not provide a means for adjusting the length of the tool while being able to activate or deactivate the magnet and at the same time flex the tool anywhere along its entire length to better manipulate and pick up surrounding magnetically attractable materials.

U.S. Pat. No. 1,772,126, issued to Barry on Aug. 5, 1930 is illustrative of known electromagnetic pick-up devices. Such known devices are large and cumbersome and require cords connected to large storage batteries or to a conventional source of AC current for the necessary power to operate.

U.S. Pat. No. 3,924,115, issued to Hampton et al. on Dec. 2, 1975 for combining a built-in light with an electromagnetic pick-up tool to illuminate the work area. Prior thereto, U.S. Pat. No. 1,787,922, issued to Webb on Jan. 6, 1931 for a non-switchable electromagnetic pick-up tool with a single fixed head. Subsequently, U.S. Pat. No. 2,517,325, issued to Lamb on Aug. 1, 1950 for a magnetic probe made of a permanent magnet improved with a means for altering the strength of the magnet and the shape of the magnetic field. These features are suggested as useful for surgical extraction of magnetic splinters from the eye or tissue or for industrial extraction of magnetic particles from electrical instruments.

U.S. Pat. No. 4,813,729, issued to Speckhart on Mar. 21, 1989 for a permanent magnetic retrieval tool having a housing on an elongated, flexible shaft with a remotely operable force reduction feature such as a magnetically attractable material movable between a first position and a second position relative to the permanent magnet.

On Nov. 16, 1993 Slusar et al. was issued U.S. Pat. No. 5,261,714 for an electrical version of the pick-up tool with a flexible, tubular, “conductive” shaft housing batteries and a push-button switch for connecting one battery terminal to the housing, the other battery terminal being connected to an insulated conductor which runs through the shaft for connection of one terminal of the electromagnet. The magnet is adjustable, being provided with telescoping inner and outer pole pieces.

It is thus known to provide various types of magnetic pickup tools for picking up magnetizable objects from relatively inaccessible places. For example, if a screw or nut is dropped in a difficult-to-reach place, elongated magnetic tools are frequently used for accessing the dropped part and magnetically adhering it to the tool for retrieval. One such type of tool, as described above, includes an elongated, flexible shaft, having a handle at one end and provided with a magnet at the other end. The magnet may be a permanent magnet or it may be an electromagnet, powered by suitable power supply means, such as batteries, which may be contained in the handle of the tool. One difficulty with such prior pickup tools solved by Slusar et al. is to control the flux lines of the magnet which extend laterally from the axis of the tool. Thus, if the tool is being used in a location, such as in an automotive vehicle engine compartment or the like, with metallic walls or partitions, the magnet tends to be attracted to the metal walls or partitions, making it very difficult to reach the object to be retrieved so Slusar et al. added a push-button switch part to its “conductive” non-telescoping shaft for a portable tool.

It is known to provide electromagnetic devices with conductive sleeves or outer pole pieces to alter a magnetic path for the flux lines, thereby concentrating the flux lines at a desired location, such as at the tip of the device. However, such an arrangement has not heretofore been satisfactorily provided in portable electromagnetic pickup tools by using a variety of tip shapes in combination with a plastic or non-conductive “telescoping” housing offering manually selectively variable lengths and a push-button switch whereby the problem of the wall of the tool becoming magnetized, becoming attached at an undesirable location, not being able to be flexed to reach a location, or causing an electrical short is alleviated.

### OBJECTS OF THE INVENTION

It is a general object of the invention to provide an improved magnetic pickup tool, which avoids the disadvantages of prior tools while affording additional structural and operating advantages.

An important feature of the invention is the provision of an electromagnetic pickup tool, which effectively prevents magnetic flux lines from extending into the body of the tool by making the body primarily out of non-conductive material such as plastic or the like.

Another important feature of the invention is the provision of an electromagnetic pickup tool which allows changes in the magnetic flux lines from extending from the tool by making the body primarily out of non-conductive material such as plastic or the like and allowing the tip or end cap to be interchangeable with variously shaped ones.

Yet another important feature of the invention is the provision of an electromagnetic pickup tool that effectively allows magnetic flux lines to be manually retracted and extended by adopting a telescoping non-magnetic, non-electrically conductive body mounted with a magnetizable tip that is selectively magnetically shielded with a cap having an iron content.

In connection with the foregoing feature, another feature of the invention is the provision of a pickup tool of the type set forth, which provides unique coupling means, namely, flexible coated copper wires, for mounting a selectively activated electromagnet on an elongated flexible telescoping shaft.

Another feature of the invention is the provision of a pickup tool of the type set forth and illustrated, which is battery-powered, wherein the shaft and the handle of the tool provides a part of the electrical circuit for the electromagnet.

Still another feature of the invention is the provision of a pickup tool of the type set forth, which is of relatively simple and economical construction and readily manufactured.

In the prior art, telescoping electromagnetic tools refer to adjusting the magnetic flux using a telescoping electromagnetic conducting metal sleeve. The novel retractable electromagnetic tool of the invention consists of a telescoping series of non-metallic, concentric cylinders that are reducible into the largest cylinder with the smaller cylinder being mounted with magnetizable tip having a selected shape. Heretofore, a simple rod retractable small electromagnetic tool was not available due to size constraints of the interior of the mechanical housing. Conventional designs specified telescoping electromagnetic tools as rigid metallic cylinders prone to permanent bending. Once bent, the cylinders lose their concentricity, and the process of retracting the electromagnetic tool becomes increasingly difficult and often results in breakage. Furthermore, since telescoping electromagnetic tool designs retract into a base metallic magnetizable cylinder, performance is severely degraded in the stowed position.

### SUMMARY OF THE INVENTION

These and other features of the invention are attained by providing a portable magnetic pickup tool comprising: A selectively elongated shaft having a handle end and a working end and a longitudinal axis extending there between, manually selectively variable magnetic means tipping the shaft at its working end for generating a magnetic field which extends there from, the handle being a telescoping substantially hollow non-conductive, resilient tubular structure resembling a combination of a ballpoint and telescoping pointer with small diameter insulated flexible copper wires therein selected due to their flexibility, malleability, and low breakage after repeated flexing.

### BRIEF DESCRIPTION OF THE DRAWINGS

The above objects and other features, aspects, and advantages of the present invention will become better understood with regard to the following description, appended claims, and accompanying drawings wherein:

FIG. 1 is an elevation view of the flexible telescoping electromagnetic tool according to the present invention;

FIG. 2 is a cross-sectional view of the electromagnetic tool illustrated in FIG. 1; and

FIG. 3 is a circuit diagram of the electrical circuit of the novel invention.

### DESCRIPTION OF THE PREFERRED EMBODIMENTS

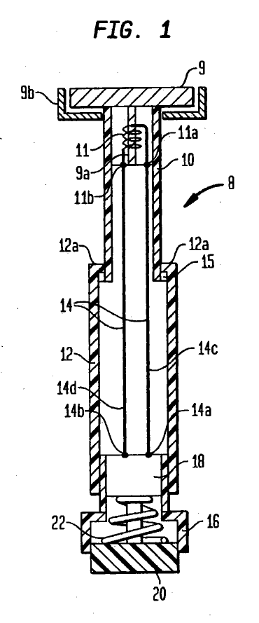

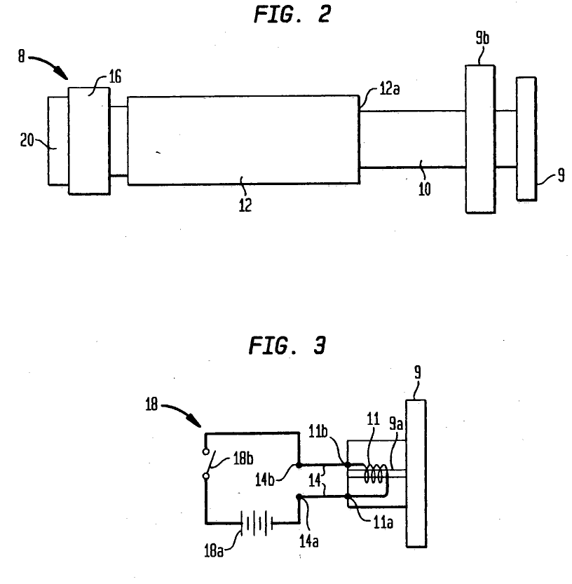

Referring to FIGS. 1 and 2, the assembly of the flexible telescoping electromagnetic tool 8 according to the present invention is illustrated. The electromagnetic tool 8 is constructed in the manner of a collapsible wand, ballpoint pen or flashlight with a selectively actuated electromagnet at a tip thereof. The actuated electromagnetic tip is used to attach, move, manipulate, and/or pick up magnetizable objects such as screws, bolts, nuts, nails, tacks, and the like. The electromagnetic tool 8 is made of an end member or end cap 9 capping a tubular end section 10.

The end cap 9 is formed of a magnetizable material such as a nickel iron alloy and has an integral extension 9a that is coated with an electrical insulator and wrapped with an inductor 11 having contacts 11a and 11b as shown in FIG. 1 and in the circuit diagram of FIG. 3. Alternatively, the inductor 11 may be made of wire having an electrically insulating coating; and then, the extension 9a may be uncoated. Most importantly for proper operation and utility, the end cap 9 is selectively magnetically shielded using a cover 9b made of iron or an impregnated plastic sufficiently impregnated with iron or ferrite particles to effectively shield the magnetic field emanating from the side of the end cap 9. The cover 9b is slidable along the end section 10 and loosely covers the end so as to leave an small air gap in between the surfaces of the end cap 9 covered by the cover 9b.

The end section 10 is slidably received in a tubular section 12, which is formed of a non-conducting material such as plastic, for example. The end section 10 is inserted into the tubular section 12 through an opening 12a in the tubular section 12. An electrical conductor insert 14 has electrically isolated contacts 14a and 14b connected to conductors 14c and 14d, respectively. The conductors 14c and 14d are comprised of first and second separate flexible insulated wires permanently connected to contacts 14a and 14b, respectively.

A ring insert 15 having a width greater than a diameter of the opening 12a is press fit or otherwise secured on the proximal end of end section 10 to prevent the end section 10 from being separated from the tubular section 12. Multiples or pluralities of the sections 10 and 12 may be assembled and the insert 14 lengthened to increase the length of the magnetic pick up tool. Likewise, the end section 10 may be selected from a variety of shapes such as L-shaped, C-shaped, or oblique angled, for example, for adaptation to different jobs and apertures.

As shown in FIG. 1 the electric conductor insert 14 is formed of two isolated electrically conducting segments, namely conductors 14c and 14d. The insert 14 flexibly interconnects electrical contacts 11a and 11b with electrical contacts 14a and 14b, respectively. The inductor 11 is designed and oriented about the internal segment 9a of the end cap so as to terminate in the contacts 11a and 11b.

In accordance with another aspect of the invention, there is provided a method of constructing the flexible telescoping electromagnetic tool noted above. The method includes the steps of (a) inserting the end section 10 into the opening 12a in the tubular section 12, (b) securing the retaining ring 15 having a width greater than the opening 12b to an end of the end section 10 inside the tubular section 12, and (c) securing the conducting insert 14 inside the tubular section 12 in electrical contact with the inductor 11 via the inductor contacts 11a and 11b. The end section 10 is inserted into the compact electromagnetic tool in a friction fit such that the compact electromagnetic tool supports the tubular section 12 and the end section 10. The method may further include securing the tubular section 12 to a subsequent tubular section. Step (c) may be practiced by securing the conducting insert 14 inside the tubular section 12 radially offset from a central axis of the tubular section 12.

Thus, the method of making the tool 8, comprises the step of inserting electrically insulated and electrically conducting wires 14c and 14d in the tubular section 12 and extending them substantially along the entire length of the tubular section 12. At its distal end, an insulated insert 16 includes an end module 18 having a battery 18a connected to a normally open switch 18b.

The end module 18 contains the battery 18a and switch 18b, parts of the circuit shown in FIG. 3 and is fitted into the distal end of the tubular section 12. In an alternative configuration, the module 18 has a pair of wires as conducting inserts 14a and 14b, which extend up through the sections 12 and 10 to the contacts 11a and 11b for the inductor 11 located about a portion 9a of the end member 9.

Referring to FIG. 2, the insert 12 is formed with conducting inserts 14a and 14b comprised of electrically isolated lengthwise strips of a thin-coated flexible copper wire. Preferably, the copper wires are disposed loosely inside the tubular sections 10 and 12. By virtue of this arrangement, the electrically isolated contacts, conducting inserts 14a and 14b of the module 18, are connected or soldered to the conductors 14c and 14d made of copper wire and thereby maintain their respective electrical contacts with the inductor 11 at any interval of extension of the electromagnetic tool. Thus, as the end section 10 is retracted, the module 18 can maintain electrical contact with the inductor 11 provided the switch 18b is closed.

The actuator for the switch 18b is a plunger button 20 maintaining the switch 18b in a normally open position via a spring 22 as shown in FIG. 1.

The electromagnetic tool 8 is useful for picking up, manipulating, and removing ferrous screws, nuts or the like. The tool 8 is intended to be compact and the size of a ballpoint pen or pen flashlight but extendable with additional sections from several inches to several feet.

The device 8 is functional as a contact or close proximity pick-up electromagnet whether or not the sections 10 and 12 are completely retracted.

As shown in FIG. 2, the electrical contacts of the electromagnetic tool conducting materials are preferably galvanic contacts. However, the electrical contacts can be achieved with a frictional engagement between separate conductive strips on the inside surface of the sections 10 and 12. In addition, although the FIGURES illustrate two tubular sections 10 and 12 extending between the end cap 9 formed as a flat round magnetizable pick-up head, for example, and the power supply and switching module 18, those of ordinary skill in the art will appreciate that subsequent tubular sections could be provided and that the magnetizable pick-up head can be in many shapes in addition to those mentioned above including basket, needle, square, or hooked, for example. In this regard, each tubular section may include conducting inserts similar to inserts 14c and 14d and contacts similar to contacts 14a and 14b.

The flexible telescoping electromagnetic tool according to the invention utilizes plastic telescoping sections and conducting elements of solid small diameter flexible interconnecting coated wires or a pair of copper strips inside each section. The electromagnetic tool is thus less susceptible to breakage allowing maximum mechanical deflection of the telescoping sections without permanent deformation of the electromagnetic tool while providing optimum mechanical pick-up performance.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A flexible telescoping electromagnetic tool comprising:
an end cap formed of a magnetizable material; an end section formed of a non-magnetizable material, said end cap being connected to said end section;
a tubular section formed of a non-magnetizable material, said tubular section slidably receiving said end section; and
an electrically conducting insert disposed through said tubular section and through said end section, said conducting insert electrically connected to an end plug power supply and switch module at a distal end of said tubular section, said module attached to the distal end of said non-magnetizable tubular section.

2. An electromagnetic tool according to claim 1, wherein said end section is slidable through an opening in said tubular section, the electromagnetic tool further comprising a ring insert secured to an end of said end section, said ring insert being formed of a plastic material and having a width that is greater than a diameter of said opening, said ring insert being attached outside a proximal end of said end section inside said tubular section and wherein said electrically conducting insert comprises electrical connection with an inductor, said inductor having two contacts and being near said end cap.

3. An electromagnetic tool according to claim 2, wherein said electrically conducting insert is disposed in said tubular section.

4. An electromagnetic tool according to claim 3, wherein said conducting insert is disposed against a portion of an inside wall of said tubular section.

5. An electromagnetic tool according to claim 4, wherein said conducting insert is comprised of first and second electrically isolated conductors, the first conductor being connected to one contact of said inductor contacts and the second conductor being connected to another contact of said inductor.

6. An electromagnetic tool according to claim 2, wherein said electrical contacts are galvanic contacts.

7. An electromagnetic tool according to claim 2, wherein magnetization of said end cap is achieved with electrical inductance via said inductor.

8. An electromagnetic tool according to claim 2, further comprising at least one subsequent tubular section formed of a non-conducting material, said at least one subsequent tubular section slidably receiving one of said tubular section and other subsequent tubular sections.

9. An electromagnetic tool according to claim 2, further comprising a compact electromagnetic tool selectively securable to a magnetizable object.

10. An electromagnetic tool according to claim 9, wherein said end section includes a first part having a reduced width substantially corresponding to a diameter of said tubular section and a second part having a width greater than the diameter of said tubular section.

11. An electromagnetic tool according to claim 8, further comprising an end tube at the distal end of said tubular section, said end tube has a width substantially corresponding to a diameter of said tubular section, the electromagnetic tool further comprising a power supply and switch module secured to said end tube, said module being electrically connected via said electrically conducting insert to said inductor, said module having two conducting contacts connected to said electrically conducting insert, said module having a width that is substantially equal to the diameter of said tubular section, wherein said end plug of said insert is in electrical contact with said stop cap.

12. An electromagnetic tool according to claim 8, wherein said compact electromagnetic tool comprises a plastic coated helix coil.

13. An electromagnetic tool according to claim 1, further comprising a compact electromagnetic tool having an electrical switch at the distal end of a subsequent tube section, said electrical switch being springingly supported at the distal end of said subsequent tube section.

14. An electromagnetic tool according to claim 12, wherein said subsequent tube section includes a first section having a reduced width substantially corresponding to a diameter of said tubular section and a second section having a width greater than the diameter of said tubular section.

15. An electromagnetic tool according to claim 12, wherein said subsequent tube section has a width substantially corresponding to a diameter of said tubular section, the electromagnetic tool further comprising a switch member secured to said module, a portion of said switch member being formed of a conducting material located inside said module and another portion of said switch member having a width that is less than the diameter of said subsequent tube section, wherein actuation of the switch connected to said module forms an electrical contact of said power supply with said inductor.

16. An electromagnetic tool according to claim 14, wherein said non-conducting material is plastic.

17. An electromagnetic tool according to claim 1, wherein said module is covered with a non-conducting material.

18. An electromagnetic tool according to claim 1 wherein said end cap is a tip of a selected shape having non-contact portions, the tool further comprising a covering means for partially covering said tip, said covering means magnetically shielding non-contact portions of said tip.

19. A method of constructing a flexible telescoping electromagnetic tool including an end section with a tip formed of a conducting material, a tubular section formed of a non-conducting material, and a conducting insert disposed in the tubular section in electrical contact with the end section, the conducting insert having an inductor means at a distal end for magnetizing said tip, the method comprising:
(a) inserting the end section into an opening in the tubular section;
(b) securing an end cap having a width greater than the opening to an end of the end section, the end cap having a magnetizable portion surrounded by said inductor inside the end section;
(c) inserting the conducting insert inside the non-conducting tubular section in electrical contact with the end cap and securing the inductor to the conducting insert with the end plug;
(d) inserting the tubular section into a compact electromagnetic tool in a friction fit, the compact electromagnetic tool supporting the tubular section and the end section to an apparatus requiring the electromagnetic tool;
(e) securing the tubular section to a subsequent tubular section;

20. A flexible telescoping electromagnetic tool comprising:
an end section formed of a conducting material;
a tubular section formed of a non-conducting material, said tubular section slidably receiving said end section; and
a conducting insert disposed in said tubular section in electrical contact with said end cap regardless of a position of said end section along said conducting insert, said conducting insert having a power supply module at a distal end thereof, said module connected to said conducting insert, said conducting insert extending through said non-conducting tubular section.
